(19) United States
(12) Patent Application Publication
(10) Pub. No.: US 2003/0202015 A1
(43) Pub. Date: Oct. 30, 2003

(54) Imaging device user interface method and apparatus

(76) Inventors: Amy E. Battles, Windsor, CO (US); Robert Cazier, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/137,080

(22) Filed: Apr. 30, 2002

(51) Int. Cl. G09G 5/00

(52) U.S. Cl. 345/764; 345/768

(57) ABSTRACT

An imaging device user interface allows intents or menu options associated with an image to be set while the image is being viewed. The user interface facilitates the displaying of a large number of icons associated with the intents or menu options and easy viewing of which intents or menu options are active.

### FIELD OF THE INVENTION

The present invention relates generally to imaging devices and more specifically to imaging device user interfaces.

### BACKGROUND OF THE INVENTION

Imaging devices such as digital cameras have become increasingly complex and sophisticated since their introduction. Current digital cameras offer a variety of features and options, including the ability to specify tasks called “intents” that are performed after the imaging device is connected to another device such as a personal computer. For example, a user might set an intent that a particular image is to be emailed to a friend or family member upon connection to a PC.

Presenting the user with the myriad of options, including those associated with intents, in an uncluttered and efficient manner on a small display is challenging. It is thus apparent that there is a need in the art for an improved imaging device user interface.

### SUMMARY OF THE INVENTION

A user interface method for setting intents in an imaging device is provided. An apparatus for carrying out the method is also provided.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a functional block diagram of an imaging device in accordance with an illustrative embodiment of the invention.

FIG. 2A is an illustration of a menu for setting intents in the imaging device shown in FIG. 1 in accordance with an illustrative embodiment of the invention.

FIG. 2B is an illustration of another menu for setting intents in the imaging device shown in FIG. 1 in accordance with an another illustrative embodiment of the invention.

FIG. 3 is an illustration of an input control in accordance with an illustrative embodiment of the invention.

FIG. 4 is a flowchart of the operation of the imaging device shown in FIG. 1 in accordance with an illustrative embodiment of the invention.

FIG. 5 is a flowchart of the operation of the imaging device shown in FIG. 1 in accordance with another illustrative embodiment of the invention.

FIG. 6 is a flowchart of the operation of the imaging device shown in FIG. 1 in accordance with yet another illustrative embodiment of the invention.

### DETAILED DESCRIPTION OF THE INVENTION

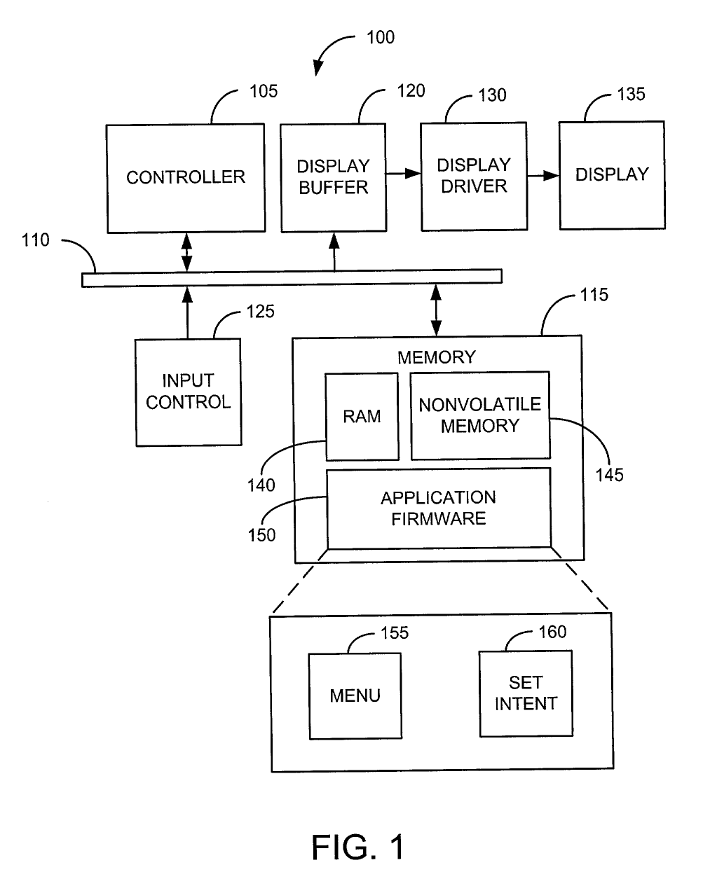

FIG. 1 is a functional block diagram of an imaging device 100 in accordance with an illustrative embodiment of the invention. Imaging device 100 may be, for example, a digital camera, personal digital assistant (PDA), palmtop computer, notebook computer, radiotelephone, or any other device capable of storing and displaying digital images. In FIG. 1, controller 105 communicates over data bus 110 with memory 115, display buffer 120, and input control 125. The output of display buffer 120 is fed to display driver 130, which in turn drives LCD display 135. Display buffer 120 is configured to interleave two images for simultaneous display on display 135, one image being a background image and the other being a foreground or overlay image. These two image layers will also be referred to as a “back plane” and a “front plane,” respectively.

Memory 115 further comprises random access memory (RAM) 140, nonvolatile memory 145, and application firmware 150. One or more digital images may be stored in nonvolatile memory 145, which may be of the removable variety. Application firmware 150 comprises stored program code. The stored program code may include menu module 155 and set-intent module 160.

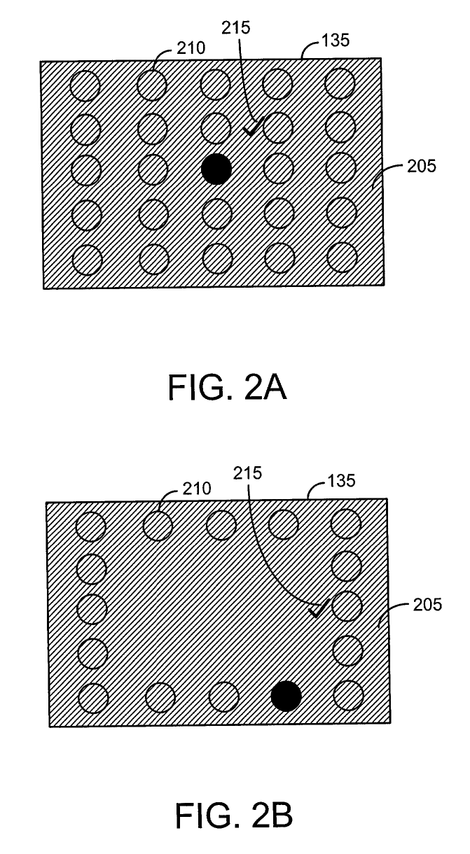

FIGS. 2A and 2B illustrate possible implementations of menu module 155 for setting intents in imaging device 100 in accordance with illustrative embodiments of the invention. In both figures, the crosshatched area 205 represents an image in the back plane (a background image). In FIG. 2A, control elements (icons) 210 in the front plane are superimposed over background image 205 in a two-dimensional grid. To facilitate viewing background image 205, the icons 210 are nominally translucent. One icon (indicated by the black circle) has focus at any given time and may be displayed as opaque to differentiate it from the other icons. Thus, any given icon 210 may become opaque upon acquiring focus. Using input control 125, a user may navigate to any desired icon 210 to give it focus. Associated with at least one icon 210 is an “intent,” a task involving the current background image 205 that is performed after imaging device 100 has been connected to a second device such as a personal computer or printer. For example, an icon 210 may have an intent called “email grandma” associated with it. Such an intent can be used to e-mail the associated background image 205 after connection to a second device. To set an intent, the user may give focus to the associated icon 210 and use input control 125 to “select” that Page 3 of 12 icon. Once an intent has been set, check mark 215 or another method such as a color and/or opaqueness change to the corresponding icon 210 may be used to indicate visually that the intent has been set.

Other icons 210 may be associated with menu options performed immediately on background image 205, such as magnification, rotation, color or contrast adjustment, or special effects. Also, an icon may be provided for exiting the menu module 155.

One standard for creating and managing intents that is well known in the art is the Digital Print Order Form (DPOF) standard. One advantage of the configuration shown in FIG. 2A is that a large number of icons 210 may be displayed while leaving background image 205 visible. Another advantage is that the user can see at a glance which intents or other menu options have been activated.

FIG. 2B is a variation on the scheme shown in FIG. 2A. In FIG. 2B, the icons 210 are arranged around the perimeter of display 135 to allow for clearer viewing of background image 205.

In any implementation of a menu such as those shown in FIGS. 2A and 2B, it is advantageous to provide a text label identifying the associated intent (e.g., “e-mail grandma”) near each icon 210. Such a text label may be visible at all times or “pop up” when a particular icon 210 acquires focus.

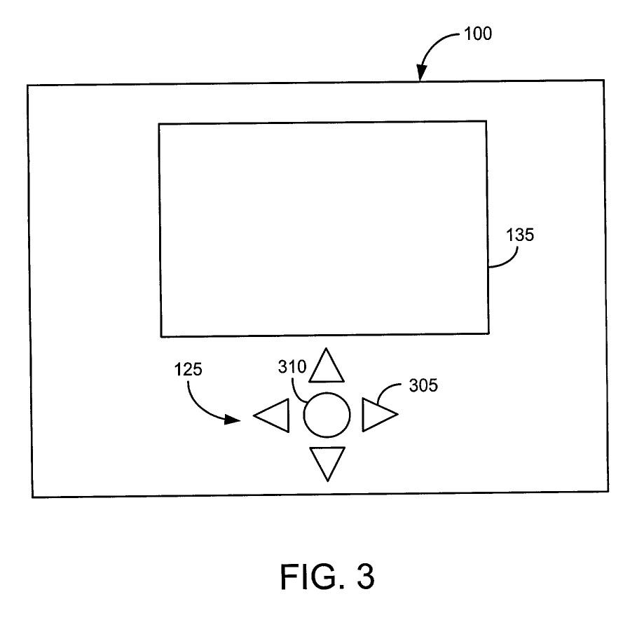

FIG. 3 is an illustration of one implementation of input control 125 in accordance with an illustrative embodiment of the invention. FIG. 3 depicts imaging device 100 with display 135 and input control 125. In this particular implementation, input control 125 comprises four directional buttons 305 and a center selection or “OK” button 310. A user may use directional buttons 305 to navigate among and give focus to icons 210. When pressed, “OK” button 310 selects the icon 210 that has focus, and set-intent module 160 sets the associated intent. A “menu” button (not shown in FIG. 3) may also be used to invoke or dismiss a menu such as those shown in FIGS. 2A and 2B. A “cancel” button (not shown in FIG. 3) may also be provided to deactivate intents or other menu options that are already active. In some embodiments, “OK” button 310 may also double as a “cancel” button. For example, if the user desires to cancel an intent or menu option that is already active, navigating to the associated icon 210 and pressing “OK” button 310 again may cancel the intent or menu option. In other embodiments, repeated presses of “OK” button 310 may cycle through three functions: changing the icon 210 having focus to opaque, setting the associated intent or menu option, and canceling an intent or menu option that is already active, respectively.

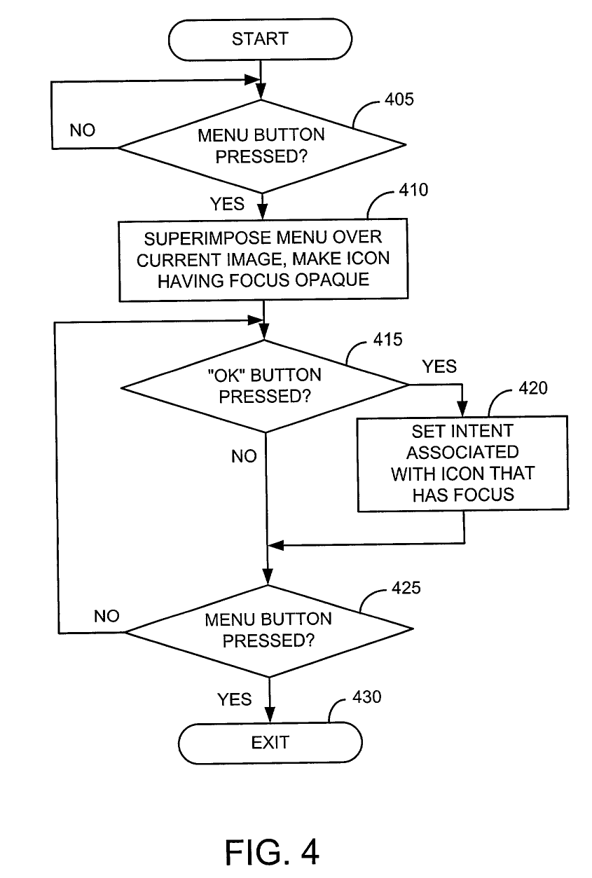

FIG. 4 is a flowchart of the operation of imaging device 100 in accordance with an illustrative embodiment of the invention. At 405, menu module 155 may be invoked by the pressing of a “menu” button. At 410, the menu is superimposed over the current background image 205 on display 135, and one icon 210 (by default the center icon in the configuration of FIG. 2A) may be given focus. In this embodiment, the icon 210 having focus is shown as opaque. If “OK” button 310 is pressed at 415, control proceeds to 420, where the associated intent is set by set-intent module 160. Otherwise, control proceeds to 425, where a press of the “menu” button exits menu module 155. If the “menu” button is not pressed at 425, control returns to 415. In this embodiment, navigating to an icon 210 for which an intent or menu option has already been activated and pressing “OK” button 310 may cancel the intent or menu option as described in connection with FIG. 3.

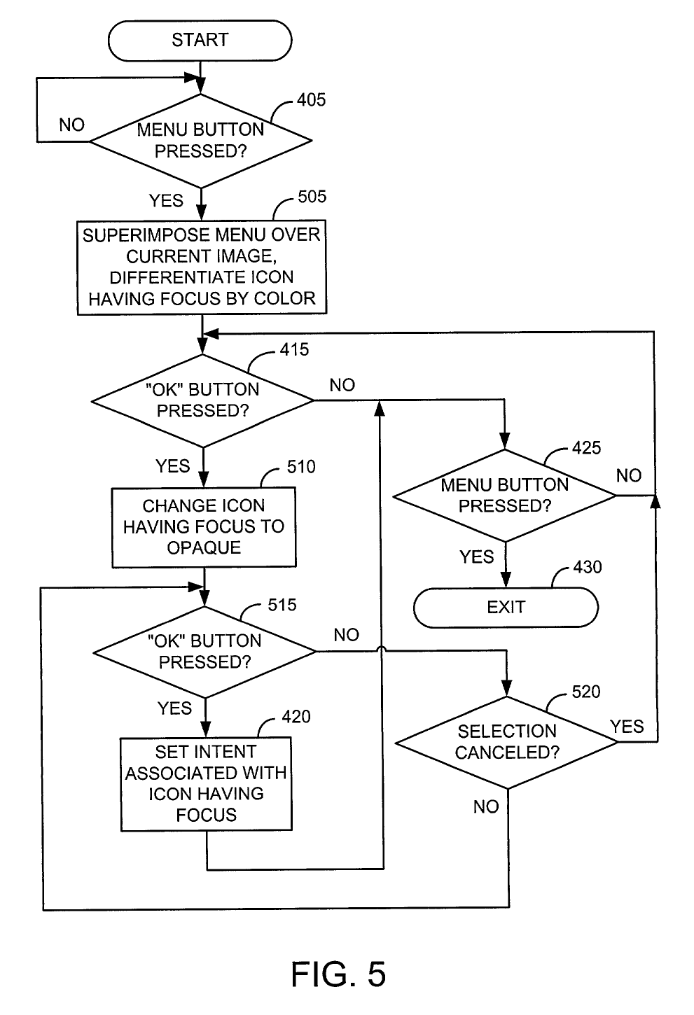

FIG. 5 is a flowchart of the operation of imaging device 100 in accordance with another illustrative embodiment of the invention. At 505, the icon 210 having focus may remain translucent instead of becoming opaque upon acquiring focus. In this particular embodiment, the icon 210 having focus may instead be differentiated by, for example, color. A press of the “OK” button at 415 changes the icon currently having focus to opaque at 510. A second press of the “OK” button at 515 invokes setintent module 160 to set the associated intent at 420. If the tentative selection is instead canceled at 520, the icon 210 that was made opaque at 510 may be changed back to translucent, and control returns to 415. For example, a three-way “OK” button 310 or a separate “cancel” button may be used to cancel the intent or menu option, as described in connection with FIG. 3. The “menu” button may be used at 425 to exit menu module 155 at 430. This embodiment provides the user with an opportunity to confirm an intent before making a final selection and allows all icons 210 to remain translucent until the user is ready to set an intent.

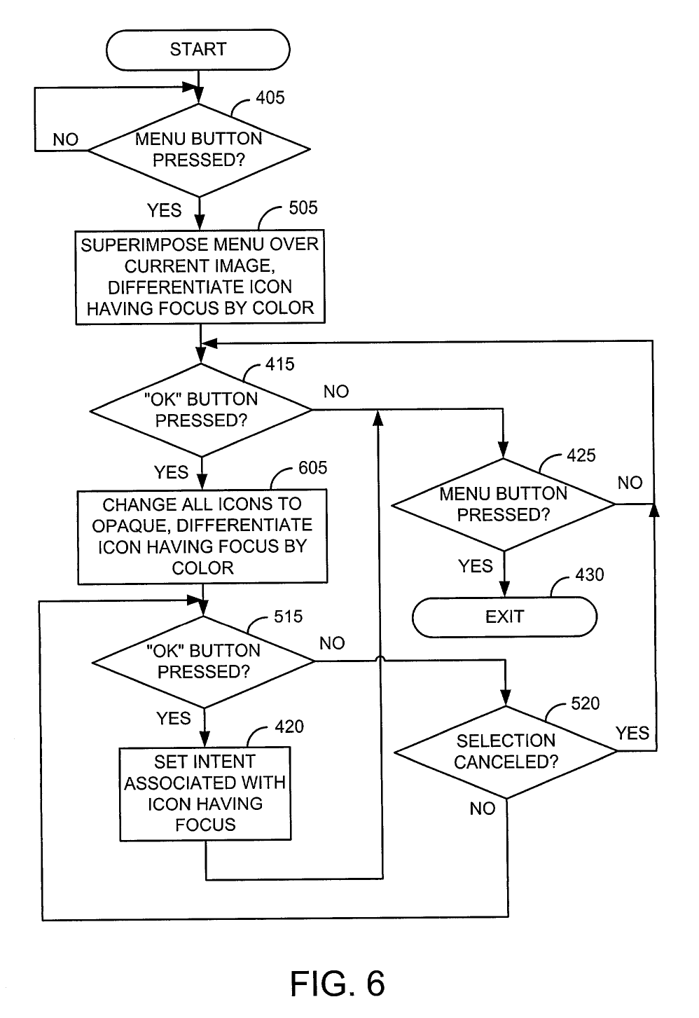

FIG. 6 is a flowchart of the operation of imaging device 100 in accordance with yet another illustrative embodiment of the invention. In this embodiment, a press of the “OK” button at 415 changes all icons 210 to opaque at 605. The icon 210 having focus may be indicated by color, size, shape, or other some other suitable method. A second press of the “OK” button at 515 invokes set-intent module 160 to set the associated intent at 420. If the tentative selection is instead canceled at 520, the icons 210 may be changed back to translucent, and control returns to 415. As mentioned in connection with FIG. 5, a three-way “OK” button 310 or a separate “cancel” button may be used to cancel the intent or menu option, as described in connection with FIG. 3. The “menu” button may be used at 425 to exit menu module 155 at 430. This embodiment provides the advantage that all icons 210 may be clearly viewed prior to the setting of a particular intent.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for setting intents associated with an image in a first device, comprising:
displaying the image;
superimposing over the image at least one translucent control element, at least one of the translucent control elements corresponding to an intent; and
setting an intent in response to the selection of the corresponding translucent control element.

2. The method of claim 1, wherein one of the at least one translucent control elements has focus at any given time.

3. The method of claim 2, wherein the translucent control element having focus becomes opaque upon acquiring focus.

4. The method of claim 2, wherein the translucent control element having focus changes color upon acquiring focus.

5. The method of claim 4, wherein the translucent control element having focus becomes opaque in response to a first input signal and the corresponding intent is set in response to a second input signal.

6. The method of claim 4, wherein all translucent control elements become opaque in response to a first input signal and the intent corresponding to the translucent control element having focus is set in response to a second input signal.

7. The method of claim 1, wherein the translucent control elements are arranged in a two-dimensional pattern that substantially spans a display.

8. The method of claim 1, wherein the translucent control elements are arranged around the perimeter of a display.

9. The method of claim 1, further comprising:
executing the intent after the first device is connected with a second device.

10. An imaging device user interface, comprising:
a display;
a display buffer configured to combine for presentation on the display a background image and an overlay image comprising at least one translucent control element, at least one of the translucent control elements corresponding to an intent, each intent comprising a task to be performed after connection of the imaging device with a second device;
an input control to navigate among and select the translucent control elements; and
control logic configured to set the corresponding intent in response to the selection of a translucent control element.

11. The imaging device user interface of claim 10, wherein the imaging device is a digital camera, personal digital assistant, palmtop computer, notebook computer, or radiotelephone.

12. The imaging device user interface of claim 10, wherein the input control comprises a set of directional buttons and a button that selects a particular translucent control element having focus.

13. The imaging device user interface of claim 10, wherein the input control comprises a multi-position rocking button.

14. An imaging device user interface, comprising:
display means for displaying digital images;
buffer means configured to combine for presentation on the display means a background image and an overlay image comprising at least one translucent control element, at least one of the translucent control elements corresponding to an intent, each intent comprising a task to be performed after connection of the imaging device with a second device;
means for navigating among and selecting the translucent control elements; and
logic means for setting the corresponding intent in response to the selection of a translucent control element.

15. The imaging device user interface of claim 14, wherein the means for navigating among and selecting the translucent control elements comprises a set of directional buttons and a button that selects a particular translucent control element having focus.

16. The imaging device user interface of claim 14, wherein the means for navigating among and selecting the translucent control elements comprises a multi-position rocking button.

17. The imaging device user interface of claim 14, wherein the imaging device is a digital camera, personal digital assistant, palmtop computer, notebook computer, or radiotelephone.
